(19) United States
(12) Patent Application Publication
(10) Pub. No.: US 2009/0214167 A1
(43) Pub. Date: Aug. 27, 2009

(54) Optical Cable Buffer Tube with Integrated Hollow Channels

(75) Inventors: Boyce Lookadoo, Hickory, NC (US); Don Parris, Newton, NC (US)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Draka Comteq B.V., Amsterdam (NL)

(21) Appl. No.: 12/391,327

(22) Filed: Feb. 24, 2009

Related U.S. Application Data
(60) Provisional application No. 61/031,049, filed on Feb. 25, 2008.

(51) Int. Cl. G02B 6/44

(52) U.S. Cl. 385/100

(57) ABSTRACT

Disclosed is a buffer tube that incorporates hollow channels into its wall. This reduction in material moderates the buffer tube's thermal expansion and contraction.

### CROSS-REFERENCE TO PRIORITY APPLICATION

This U.S. nonprovisional application hereby claims the benefit of pending U.S. Provisional Application No. 61/031,049 for an Optical Cable Buffer Tube with Integrated Hollow Channels (filed Feb. 25, 2008), which is hereby incorporated by reference in its entirety.

### BACKGROUND OF THE INVENTION

Optical fiber cables are used to transmit information including telephone signals, television signals, data signals, and Internet communication. Such optical fiber cables are typically designed to impart little, if any, physical or mechanical loads onto the optical conductors (e.g., optical fibers) positioned therein. In this regard, optical fiber cable jacketing is typically formed from polymeric materials and thus will thermally expand and contract significantly more than the optical conductors (e.g., glass fibers).

To further reduce stress upon the optical conductors, the optical conductors are often encased in a buffer tube. Within a buffer tube, the optical conductors can freely bend and straighten as the surrounding polymeric cable jacketing (and buffer tube) expand and contract.

It is desirable to reduce the free space within a buffer tube in order to achieve smaller optical fiber cables. Consequently, it is desirable to reduce, if not minimize, the expansion and contraction of the cable jacketing and buffer tube.

The conventional solution for reducing cable expansion and contraction is to employ fiberglass (i.e., glass-reinforced plastic) and/or steel rods that possess inherently high modulii and low coefficients of thermal expansion. These rods, which can be positioned in the annular space defined by the cable jacketing or embedded within the cable jacketing itself, function as “anti-buckling” elements to resist the expansion and contraction tendencies of the polymeric cable elements. These rods are also commonly contained within the center of a cable with the optical conductor buffer tube(s) stranded around a central anti-buckling rod, or, in the case of a single tube cable, the “anti-buckling” rods are embedded in the cable jacket that surrounds the buffer tube.

Although these prior solutions work well, it would be beneficial to introduce alternative solutions that achieve smaller and/or more cost-effective optical fiber cables.

### SUMMARY OF THE INVENTION

Accordingly, it is an object of the present invention to incorporate hollow channels (e.g., tunnel-like void spaces) into the wall of a buffer tube. This reduces the amount of material required for the buffer tube, thereby reducing the buffer tube's thermal expansion and contraction.

It is another object of the present invention to reduce the expansion and contraction of optical cables and/or the buffer tubes positioned therein. Controlling expansion and contraction facilitates the design of reduced-diameter optical fiber cables by employing buffer tubes that provide less free space (i.e., smaller buffer tubes).

It is yet another aspect of the present invention to reduce material usage in optical fiber cables or buffer tubes to reduce costs.

It is yet another aspect of the present invention to reduce cable weight.

It is yet another aspect of the present invention to reduce the number and/or size of anti-buckling elements required in an optical fiber cable, thereby reducing cable costs. In this regard, the reduced effects of thermal expansion and contraction can be more readily offset (i.e., counteracted) by the same number of (or even fewer) anti-buckling elements.

It is yet another aspect of the present invention to provide a buffer tube than is capable of enclosing (i) one or more optical conductors within its central interior space and (ii) one or more optical conductors within a duct (i.e., a hollow channel) formed within the buffer tube's wall.

The foregoing, as well as other objectives and advantages of the invention and the manner in which the same are accomplished, is further specified within the following detailed description and its accompanying drawings.

### BRIEF DESCRIPTION OF THE DRAWINGS

FIG. 1 depicts an exemplary buffer tube having a wall that defines axially oriented hollow channels (i.e., ducts along the length of the buffer tube).

FIG. 2 depicts an exemplary buffer tube having a wall that defines helically oriented hollow channels (i.e., helical ducts).

FIG. 3 depicts an exemplary buffer tube having a wall that defines hollow channels in a wavelike configuration (e.g., sinusoidal ducts).

FIGS. 4-7 depict exemplary buffer tubes having walls that define ducts (i.e., hollow channels) of various cross-sectional shapes.

### DETAILED DESCRIPTION

This present invention embraces a buffer tube that incorporates hollow channels (e.g., enclosed ducts) into its wall structure yet provides sufficient mechanical protection to the optical conductors that are positioned within the buffer tube's central cavity.

The present buffer tube having hollow-channeled walls requires less material, thereby moderating thermal expansion and contraction. In addition, as compared with a conventional, solid-walled buffer tube, the buffer tube according to the present invention possesses reduced weight per unit length.

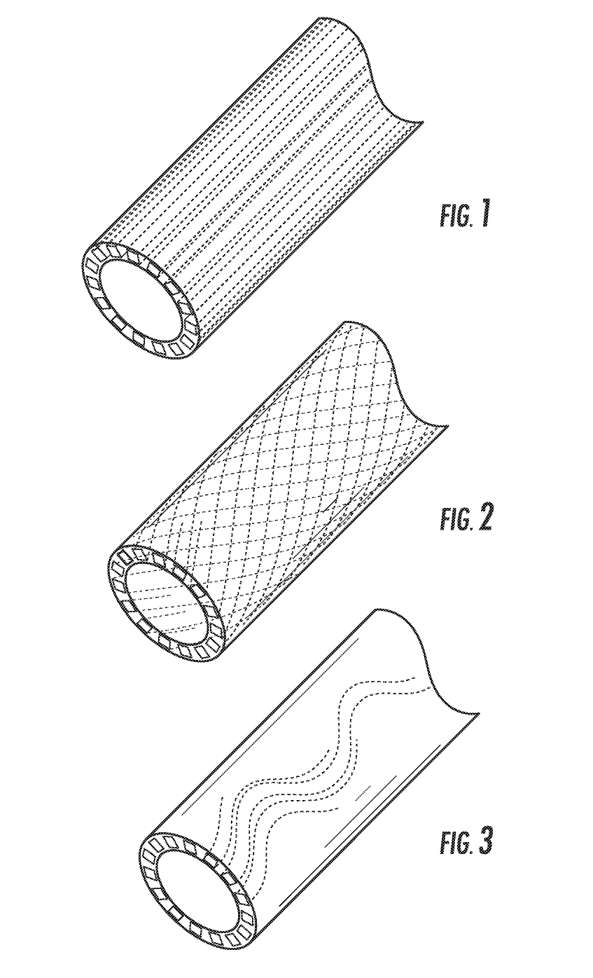

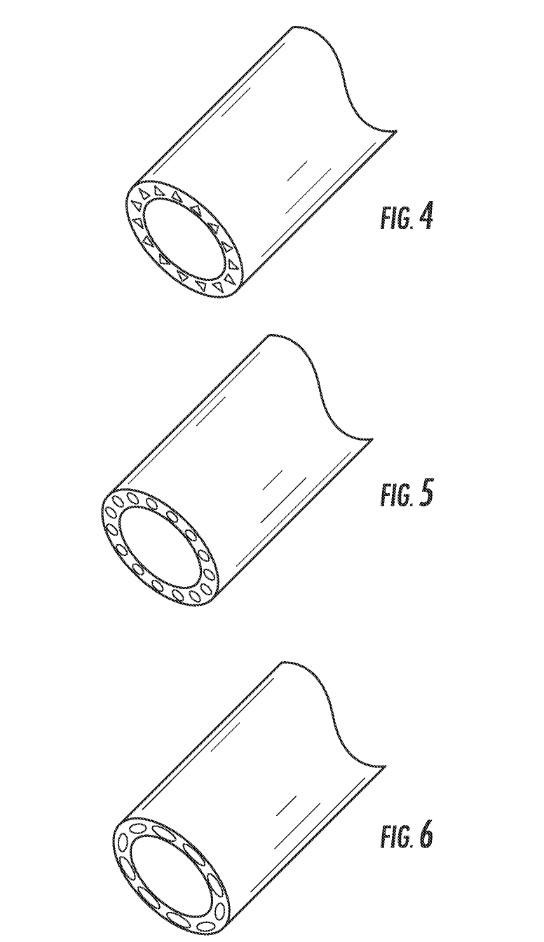

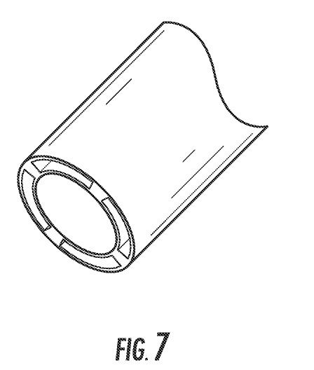

As depicted in FIGS. 1-7, within the buffer tube's wall, the hollow channels (e.g., tunnel-like passages integrated within the buffer tube's wall) may be variously configured (e.g., 100 percent axially oriented along the length of the buffer tube) and/or may embrace virtually any cross-sectional shape (e.g., oval or rectangular cross-sections).

As depicted by FIGS. 1-7, the hollow channels are typically fully integrated (i.e., fully enclosed) within the buffer tube's wall such that the buffer tube's internal surface and external surfaces are substantially continuous (e.g., smooth). That said, it is within the scope of the present invention to form hollow channels within the buffer tube in a way that defines grooves (e.g., trenches) on buffer tube's internal or external surface.

The buffer tubes according to the present invention typically are substantially cylindrical (i.e., having a circular cross-section) but can also embrace other shapes (e.g., buffer tubes having rectangular or oval cross-section). Likewise, the cable jacket, which encloses one or more such buffer tubes and optical conductors, typically is substantially cylindrical but can embrace other shapes without departing from the scope of the present invention.

In one embodiment of the present invention, the buffer tube's hollow channels are sufficiently large to carry one or more optical fibers (e.g., bundled, stranded, or ribbonized optical fibers). In this respect, the hollow channels function as conduits for optical fibers within the buffer tube's wall structure. By way of example, the buffer tube of the present invention is capable of enclosing (i) one or more optical conductors within its central cavity (i.e., its interior space) and/or (ii) one or more optical conductors within a duct (i.e., hollow channel) formed within (i.e., integrated into) the buffer tube's wall.

In general, the hollow channels or passages that are formed within the buffer tube's walls can be fairly expansive, provided that sufficient crush-resistance is maintained.

The typical design calculations for cable expansion and contraction include the product of the tensile modulus (E), the effective cross-sectional area (A), and the coefficient of thermal expansion (α) (i.e., E·A·α). Accordingly, a component with a smaller cross-sectional area contributes less to the expansion or contraction of the composite structure. Given that thermoplastic materials expand and contract much more readily than does glass (e.g., about two orders of magnitude greater), it is desirable to minimize the expansion and contraction of the thermoplastic materials (e.g., buffer tubes and cable jacketing) in an optical fiber cable.

Without being limited to a particular theory, it is thought that the buffer tube according to the present invention (i.e., characterized by integrated hollow channels) will have less shrinkage as a result of post-extrusion, secondary crystallization. This, in turn, may facilitate increased line speeds during buffering operations.

It is further thought that, over time on a reel (e.g., from a few minutes to several hours or more), the buffer tube according to the present invention will provide more consistent excess fiber or ribbon lengths (i.e., prior to cable jacketing).

The composition of the buffer tubes is not particularly limited and may include, for example, polyolefins (e.g., polypropylene or polyethylene, such as LLDPE or HDPE) or polyesters (e.g., polybutylene terephthalate). In accordance with the present invention, it may be possible to employ less of a material that has a relatively higher tensile modulus (e.g., polybutylene terephthalate) rather than more of a polyolefin (e.g., polyethylene or polypropylene), which has a relatively lower tensile modulus, and still achieve favorable results.

Those having ordinary skill in the art will appreciate that the buffer tubes according to the present invention can be employed in fiber optic cables having various configurations. For example, such fiber optic cables employing buffer tubes are disclosed in U.S. application Ser. No. 11/424,112 (Water-Swellable Tape, Adhesive-Backed For Coupling When Used Inside A Buffer Tube), filed Jun. 14, 2006, and published Jan. 25, 2007, as U.S. Patent Application Publication No. 2007/0019915 A1; U.S. application Ser. No. 11/672,714 (Optical Fiber Cable Suited for Blown Installation or Pushing Installation in Microducts of Small Diameter), filed Feb. 8, 2007, and published Aug. 9, 2007, as U.S. Patent Application Publication No. 2007/0183726 A1; U.S. application Ser. No. 11/963,048(Semi-Tight Optical Fiber Unit), filed Dec. 21, 2007, and published Jan. 8, 2009, as U.S. Patent Application Publication No. 2009/0010602 A1; U.S. application Ser. No. 12/018,604 (Gel-Free Buffer Tube with Adhesively Coupled Optical Element), filed Jan. 23, 2008, and published Jun. 19, 2008, as U.S. Patent Application Publication No. 2008/0145010 A1; and U.S. application Ser. No. 12/023,386 (Fiber Optic Cable Having a Water-Swellable Element), filed Jan. 31, 2008, and published Jul. 31, 2008, as U.S. Patent Application Publication No. 2008/0181564 A1. Each of these commonly owned patent documents is hereby incorporated by reference in its entirety.

In the specification and figures, typical embodiments of the invention have been disclosed. The present invention is not limited to such exemplary embodiments. Unless otherwise noted, specific terms have been used in a generic and descriptive sense and not for purposes of limitation.

1. A fiber optic cable, comprising:
an optical conductor;
a buffer tube enclosing said optical conductor within said buffer tube's central cavity, said buffer tube possessing a wall that defines therein one or more hollow channels; and
a cable jacket surrounding said buffer tube and its enclosed optical conductor.

2. A fiber optic cable according to claim 1, wherein at least one hollow channel is substantially enclosed within the structure of said buffer tube's wall.

3. A fiber optic cable according to claim 1, wherein the one or more hollow channels are formed along the length of said buffer tube.

4. A fiber optic cable according to claim 3, wherein the one or more hollow channels are substantially axially formed along the length of said buffer tube.

5. A fiber optic cable according to claim 3, wherein the one or more hollow channels are substantially helically formed along the length of said buffer tube.

6. A fiber optic cable according to claim 3, wherein the one or more hollow channels are formed along the length of said buffer tube in a wavelike configuration.

7. A fiber optic cable according to claim 1, further comprising at least one optical fiber that is positioned within one of said buffer tube's hollow channels.

8. A fiber optic cable according to claim 1, wherein said buffer tube possesses a substantially cylindrical wall.

9. A fiber optic cable, comprising one or more optical fibers positioned within a buffer tube, said buffer tube defining one or more ducts integrated within said buffer tube's wall.

10. A fiber optic cable according to claim 9, wherein at least one or more ducts is substantially enclosed within said buffer tube's wall.

11. A fiber optic cable according to claim 10, further comprising at least one optical conductor enclosed within one of said buffer tube's integrated wall ducts.
